(19) United States
(12) Patent Application Publication
(10) Pub. No.: US 2023/0159696 A1
(43) Pub. Date: May 25, 2023

(54) RESIN COMPOSITION AND AIR INTAKE HOSE INCLUDING THE SAME

(71) Applicants: Hyundai Motor Company, Seoul (KR); Kia Corporation, Seoul (KR); Hanwha Solutions Corporation, Seoul (KR)

(72) Inventors: Young Hak Jang, Seoul (KR); Jong Min Park, Incheon (KR); Yong Jun Cho, Seoul (KR); Hoon Jeong Kim, Sejong (KR)

(21) Appl. No.: 17/889,192

(22) Filed: Aug. 16, 2022

(30) Foreign Application Priority Data
Aug. 20, 2021 (KR) 10-2021-0109814

(51) Int. Cl. C08G 63/183; C08G 63/66; C08F 10/08; C08F 220/32; C08K 5/521; C08K 5/18; C08K 5/13; C08K 3/04; C08K 3/08; F16L 9/12

(52) U.S. Cl. CPC C08G 63/183; C08G 63/66; C08F 10/08; C08F 220/325; C08K 5/521; C08K 5/18; C08K 5/13; C08K 3/04; C08K 3/08; F16L 9/12; C08K 2003/085

(57) ABSTRACT

Disclosed are a resin composition and a vehicle part (e.g., an air intake hose) including the same. The resin composition includes a base resin and an additive, the base resin including a polyester-based elastomer and an engineering plastic. As manufactured using the resin composition described herein, the air intake hose may have a low specific gravity and excellent oil resistance and mechanical properties.

### CROSS-REFERENCE TO RELATED APPLICATION

This application claims under 35 U.S.C. § 119(a) the benefit of priority to Korean Patent Application No. 10-2021-0109814, filed on Aug. 20, 2021, the entire contents of which are incorporated herein by reference.

### TECHNICAL FIELD

The present invention relates to a resin composition and a vehicle part (e.g., an air intake hose) including the same. The resin composition may include a base resin and an additive, the base resin includes a polyester-based elastomer and an engineering plastic. The vehicle part, such as air intake hose, may have a low specific gravity as well as excellent oil resistance and mechanical properties as being manufactured using the resin composition.

### BACKGROUND

An air intake hose mounted on a vehicle functions to send air sucked from the outside of the vehicle to an air cleaner or air purified by the air cleaner to a throttle body of an engine of the vehicle and is mounted in an engine room of the vehicle, in which an air flow path between the engine and the air cleaner is formed.

Conventionally used intake hoses have had problems of low durability due to low heat resistance and of unsuitability for realization of the target quality and weight reduction due to the high weight and specific gravity thereof because an acrylate ethylene methyl material or expensive thermoplastic ester ether elastomer (TCE-ET) material and an ECO material suitable for normal temperatures are used for parts subjected to high temperatures, and a clamp is used to connect parts.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is a vehicle part (e.g., an air intake hose) having improved durability and reduced weight, formed of a low-cost material and has excellent mechanical strength, and having excellent heat resistance and oil resistance.

The objects of the present invention are not limited to those described above. Other objects of the present invention will be clearly understood from the following description, and are able to be implemented by means defined in the claims and combinations thereof.

In one aspect, provided is a resin composition including a base resin and an additive. The base resin may include a polyester-based elastomer and an engineering plastic.

The additive may suitably include one or more selected from a compatibilizer, an antioxidant, a heat-resistant stabilizer, and carbon component.

The additive may include a compatibilizer, an antioxidant, a heat-resistant stabilizer, and carbon component.

The compatibilizer may suitably include an epoxy-based compatibilizer, and the antioxidant may include one or more selected from phenol-based, phosphorus-based, and amine-based antioxidants.

The engineering plastic may suitably include a polybutylene-based engineering plastic.

The base resin may suitably include an amount of about 50 to 90% by weight of the polyester-based elastomer and an amount of about 10 to 50% by weight of the engineering plastic based on the total weight of the base resin.

The base resin may suitably include an amount of about 65 to 85% by weight of the polyester-based elastomer and an amount of about 15 to 35% by weight of the engineering plastic based on the total weight of the base resin.

The additive may include an amount of about 0.5 to 2.0 parts by weight of the compatibilizer, an amount of about 0.3 to 1.0 parts by weight of the antioxidant, an amount of about 2 to 7 parts by weight of the heat-resistant stabilizer, and an amount of about 1 to 2 parts by weight of the carbon based on 100 parts by weight of the base resin.

In another aspect, provided is a vehicle part (e.g., an air intake hose) including the resin composition. Preferably, the vehicle part is an air intake hose. The air intake hose may have a specific gravity according to ASTM D792 of about 1.30 or less, a tensile strength according to ISO 37 of about 250 kgf/cm² or greater, and a shore hardness of about 40 or greater.

Other aspects and embodiments of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 shows an exemplary air intake hose manufactured in Example 1 manufactured from an exemplary resin composition the present invention.

### DETAILED DESCRIPTION

The objects described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

It will be further understood that terms such as “comprise” or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures, and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

The present invention relates to a resin composition and an air intake hose including the same, and more specifically to an air intake hose having a low specific gravity and excellent oil resistance and mechanical properties, manufactured using a resin composition including a base resin and an additive, the base resin including a polyester-based elastomer and an engineering plastic. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, each component of the resin composition and a vehicle part (e.g., an air intake hose) manufactured using the same will be described in detail.

Resin Composition

In an aspect, provided is resin composition including a base resin and an additive.

The base resin may include a polyester-based elastomer and an engineering plastic.

The polyester-based elastomer may be used as a matrix material having excellent oil resistance, durability, and elastic restoration. The polyester-based elastomer may include a compound represented by the following Formula 1.

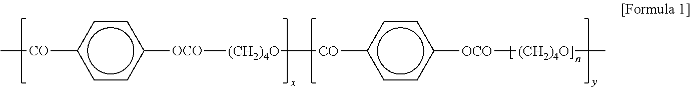

In Formula 1, x, y, and n are not particularly limited, and may be within a range capable of achieving the objects of the present invention. For example, x may be an integer from 1 to 1,000, y may be an integer from 1 to 1,000, and n may be an integer from 1 to 10.

The engineering plastic may suitably include a polybutylene-based engineering plastic, and the polybutylene-based engineering plastic may have high viscosity, heat resistance, rigidity, and long-term durability. The engineering plastic may include a compound represented by the following Formula 2.

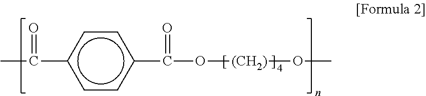

In Formula 2, n is not particularly limited, and may be within a range capable of achieving the objects of the present invention. For example, n may be an integer from 1 to 1,000.

Preferably, the base resin may suitably include an amount of about 50 to 90% by weight of the polyester-based elastomer and an amount of about 10 to 50% by weight of the engineering plastic, based on the total weight of the base resin. Preferably, the base resin may include an amount of about 65 to 85% by weight of the polyester-based elastomer and an amount of about 15 to 35% by weight of the engineering plastic, based on the total weight of the base resin.

The polyester-based elastomer and the engineering plastic may be present as a mixture or an alloy, and are preferably present as an alloy which may be suitably for improvement in miscibility between both resins and physical properties.

The additive may include one or more selected from a compatibilizer, an antioxidant, a heat-resistant stabilizer, and carbon, and preferably includes a compatibilizer, an antioxidant, a heat-resistant stabilizer, and carbon.

The compatibilizer may increase the compatibility of the polyester-based elastomer and the polybutylene-based engineering plastic, and preferably may include an epoxy-based compatibilizer. For example, the compatibilizer may include one or more selected from the group consisting of 3-epoxypropyl methacrylate, and glycidyl methacrylate.

The compatibilizer may be present in an amount of about 0.5 to 2.0 parts by weight based on 100 parts by weight of the base resin. When the content of the compatibilizer is less than about 0.5 parts by weight, the effect of obtaining compatibility cannot be obtained, and phase separation occurs between the two materials, and when the content of the compatibilizer is greater than about 2.0 parts by weight based on 100 parts by weight of the base resin, there may be a problem in that molding is incomplete during blow molding.

The antioxidant may be used to suppress oxidative degradation during blow molding, and may be present in an amount of about 0.3 to 1.0 parts by weight based on 100 parts by weight of the base resin. When the content of the antioxidant is less than about 0.3 parts by weight, the physical properties are deteriorated, and when the content of the antioxidant is greater than about 1.0 parts by weight, problems associated with appearance quality may occur.

The antioxidant may include one or more selected from phenol-based, phosphorus-based, and amine-based antioxidants.

The phosphorus antioxidant may include one or more selected from the group consisting of bis(2,6-di-ter-butyl-4-methylphenyl) pentaerythritol-diphosphite, bis(2,4-di-tert-butyl phenyl) pentaerythritol diphosphate, tris(2,4-ditert-butylphenyl), and bis(2,4-dicumylphenyl) pentaerythritol diphosphate.

The amine-based antioxidant may suitably include bis[4-(2-phenyl-2-propyl)phenyl]amine.

The heat-resistant stabilizer may improve the long-term heat resistance of molded articles, and may suitably be present in an amount of about 2 to 7 parts by weight based on 100 parts by weight of the base resin. When the content of the heat-resistant stabilizer is less than about 2 parts by weight, the effect of long-term heat resistance may be reduced, and when the content of the heat-resistant stabilizer is greater than about 7 parts by weight, problems associated with appearance quality may occur.

The carbon component may improve color stability, blow compression workability, and weather resistance, and may be used in the form of a master batch.

The carbon may suitably include a carbon block, a die block, or a combination thereof.

The carbon may suitably be present in an amount of about 1 to 2 parts by weight based on 100 parts by weight of the base resin, and when the content of the carbon is greater than about 2 parts by weight, deterioration of physical properties may occur.

The additive may suitably include an amount of about 0.5 to 2.0 parts by weight of the compatibilizer, an amount of about 0.3 to 1.0 parts by weight of the antioxidant, v2 to 7 parts by weight of the heat-resistant stabilizer, and an amount of about 1 to 2 parts by weight of the carbon based on 100 parts by weight of the base resin.

Air Intake Hose

As a vehicle part, an air intake hose of the present may include the resin composition as described herein.

The air intake hose may have a specific gravity according to ASTM D792 of about 1.30 or less, a tensile strength according to ISO 37 of about 250 kgf/cm² or greater, and a shore hardness of about 40 or greater.

The measurement method according to ISO 37 is as follows.
Specimen type: Dumbbell TYPE 1 (ISO No. 1)
Test speed: 200 mm/min

### EXAMPLE

Hereinafter, the present invention will be described in more detail with reference to specific examples. However, the following examples are provided only for better understanding of the present invention, and thus should not be construed as limiting the scope of the present invention.

### Example 1, and Comparative Examples 1 to 6

Resin compositions were prepared as shown in Table 1 below.

TABLE 1

| | | Comp. | Comp. | Comp. | Comp. | Comp. | Comp. | |
|---|---|---|---|---|---|---|---|---|
| | | Ex. 1 | Ex. 2 | Ex. 3 | Ex. 4 | Ex. 5 | Ex. 6 | Ex. 1 |
| Base resin | ECO | 100 | — | — | — | — | — | — |
| (parts by | TPE | — | 85 | 85 | 85 | 85 | 85 | 85 |
| weight) | PBT | — | 15 | 15 | — | — | — | 15 |
| | ABS | — | — | — | 15 | — | — | — |
| | TPU | — | — | — | — | 15 | — | — |
| | NBR | — | — | — | — | — | 15 | — |

| | | | | | | | |
|---|---|---|---|---|---|---|---|
| Compatibilizer | — | — | 0.5 | 1.5 | 1.5 | 1.5 | 1.5 |
| (parts by weight) | | | | | | | |
| Antioxidant | — | 0.3/0.3/0.2 | 0.3/0.3/0.2 | 0.3/0.3/0.2 | 0.3/0.3/0.2 | 0.3/0.3/0.2 | 0.3/0.3/0.2 |
| (phenol-based, | | | | | | | |
| phosphorus-based | | | | | | | |
| and amine-based) | | | | | | | |
| (parts by weight) | | | | | | | |
| Heat-resistant | — | 5 | 5 | 5 | 5 | 5 | 5 |
| stabilizer | | | | | | | |
| (parts by weight) | | | | | | | |
| Carbon | — | 1.5 | 1.5 | 1.5 | 1.5 | 1.5 | 1.5 |
| (parts by weight) | | | | | | | |

The following products were used for respective components of Table 1.
Polyester elastomer (TPE): having hardness (shore D) 40D, and melting temperature of 190° C.
PBT: having inherent viscosity of 3.0
Compatibilizer: 2,3-epoxypropyl methacrylate; glycidyl methacrylate, manufacturer (BASF)
Phenolic antioxidant: Product name (Irganox 1010), manufacturer (BASF)
Phosphorus antioxidant: Product name (Irgafos 168), manufacturer (BASF)
Amine-based antioxidant: Product name (Sunnox697), manufacturer (Sunfine Global)
Heat-resistant stabilizer: Cu
Carbon: Product name (Skypel M/B), manufacturer (SK Chemical)

### Experimental Example

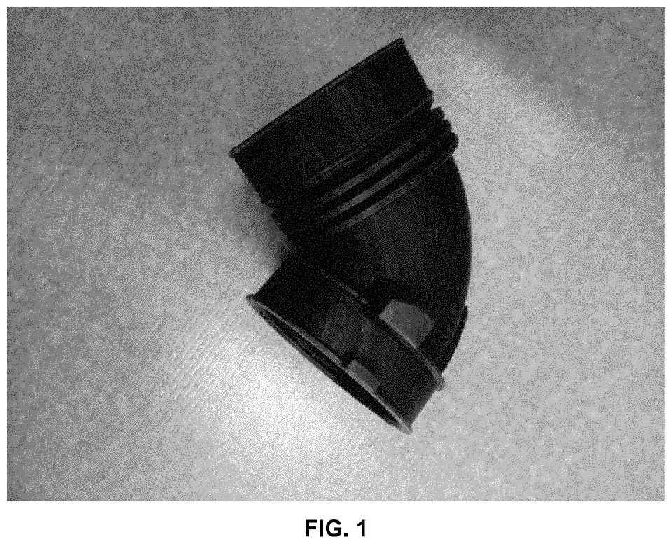

The air intake hose as shown in FIG. 1 (sample of Example 1) was molded and manufactured using each of the resin compositions of Example 1 and Comparative Examples 1 to 6 prepared above, the physical properties thereof were evaluated, and the results are shown in the following Table 2:

TABLE 2

| | Test | | Comp. | Comp. | Comp. | Comp. | Comp. | Comp. | |
|---|---|---|---|---|---|---|---|---|---|
| Item | method | Unit | Ex. 1 | Ex. 2 | Ex. 3 | Ex. 4 | Ex. 5 | Ex. 6 | Ex. 1 |
| Specific gravity | ASTM D792 | — | 1.45 | 1.16 | 1.16 | 1.17 | 1.14 | 1.13 | 1.16 |
| Tensile strength | ISO 37 | Kgf/cm² | 100 | 200 | 220 | 240 | 200 | 90 | 280 |
| Elongation | ISO 37 | % | 200 | 600 | 600 | 400 | >700 | 150 | 600 |
| Impact strength | ASTM D648 | J/m | NB | NB | NB | NB | NB | NB | NB |
| Hardness | Shore D | — | 20 | 42 | 42 | 43 | 38 | 30 | 42 |
| Oil leakage | Oil leakage | — | Absence | Absence | Absence | Presence | Absence | Presence | Absence |
| resistance | presence/absence | | | | | | | | |
| Heat resistance | Tensile | % | −99 | −38 | −98 | −90 | −38 | −99 | −25 |
| (140° C./336 hr) | variation | | | | | | | | |
| | Elongation | % | −96 | −40 | −92 | −85 | −40 | −98 | −16 |
| | variation | | | | | | | | |

In Table 2, the heat resistance test was performed by measuring changes in physical properties at a temperature of 140° C. for 336 hours. The air intake hose of Example 1 had a hardness of 42 or less, a tensile strength variation of −25%, and a break elongation rate variation of −16%, indicating excellent heat resistance.

In addition, compared to Comparative Examples 1, 2, 3, 4, and 5, Example 1 had better mechanical properties, hardness, and oil resistance, and that weight reduction is realized due to the relatively low specific gravity thereof.

Thus, according to various exemplary embodiments of the present invention, an air intake hose having improved durability and reduced weight can be provided.

Further, according to various exemplary embodiments of the present invention, an air intake hose that is formed of a low-cost material and has excellent mechanical strength can be provided.

In addition, according to various exemplary embodiments of the present invention, an air intake hose having excellent heat resistance and oil resistance can be provided.

The effects of the present invention are not limited to those mentioned above. It should be understood that the effects of the present invention include all effects that can be inferred from the description of the present invention.

The present invention has been described in detail with reference to exemplary embodiments thereof. However, it will be appreciated by those skilled in the art that changes may be made in these embodiments without departing from the principles or spirit of the present invention, the scope of which is defined in the appended claims and their equivalents.

What is claimed is:

1. A resin composition comprising:
a base resin; and
an additive,
the base resin comprising a polyester-based elastomer and an engineering plastic.

2. The resin composition according to claim 1, wherein the additive comprises one or more selected from a compatibilizer, an antioxidant, a heat-resistant stabilizer, and carbon component.

3. The resin composition according to claim 1, wherein the additive comprises a compatibilizer, an antioxidant, a heat-resistant stabilizer, and carbon component.

4. The resin composition according to claim 2, wherein the compatibilizer comprises an epoxy-based compatibilizer, and
the antioxidant comprises one or more selected from phenol-based, phosphorus-based, and amine-based antioxidants.

5. The resin composition according to claim 1, wherein the engineering plastic comprises a polybutylene-based engineering plastic.

6. The resin composition according to claim 1, wherein the base resin comprises:
an amount of about 50 to 90% by weight of the polyester-based elastomer; and
an amount of about 10 to 50% by weight of the engineering plastic,
based on the total weight of the base resin.

7. The resin composition according to claim 1, wherein the base resin comprises:
an amount of about 65 to 85% by weight of the polyester-based elastomer; and
an amount of about 15 to 35% by weight of the engineering plastic,
based on the total weight of the base resin.

8. The resin composition according to claim 3, wherein the additive comprises an amount of about 0.5 to 2.0 parts by weight of the compatibilizer, an amount of about 0.3 to 1.0 parts by weight of the antioxidant, an amount of about 2 to 7 parts by weight of the heat-resistant stabilizer, and an amount of about 1 to 2 parts by weight of the carbon component based on 100 parts by weight of the base resin.

9. A vehicle part comprising the resin composition according to claim 1.

10. The vehicle part according to claim 9 is an air intake hose.

11. The air intake hose according to claim 10, wherein the air intake hose has a specific gravity according to ASTM D792 of about 1.30 or less, a tensile strength according to ISO 37 of about 250 kgf/cm² or greater, and a shore hardness of about 40 or greater.

12. A vehicle comprising a vehicle part according to claim 9.
